(19) United States
(12) Patent Application Publication
(10) Pub. No.: US 2009/0269160 A1
(43) Pub. Date: Oct. 29, 2009

(54) Loosening Preventive Fastener for Screw Tool, and Manufacturing Method and Manufacturing Apparatus Therefor

(75) Inventor: Katsuyuki Totsu, Tokyo (JP)

Correspondence Address: Quinn Emanuel Urquhart Oliver & Hedges, LLP;Koda/Androlia, 865 S. Figueroa Street, 10th Floor, Los Angeles, CA, 90017, US

(73) Assignee: Katsuyuki Totsu

(21) Appl. No.: 12/085,104

(22) PCT Filed: Oct. 20, 2006
(86) PCT No.: PCT/JP2006/320916

§ 371 Date: May 16, 2008

(30) Foreign Application Priority Data
Nov. 18, 2005 (JP) 2005-333796

(51) Int. Cl. F16B 39/30; B21B 1/08

(52) U.S. Cl. 411/307; 72/365.2; 72/199

(57) ABSTRACT

A loosening preventive fastener for a screw tool formed in a relatively simple structure, easily manufacturable at low cost by mass production, and capable of easily and securely preventing a screw tool from being loosened as a fastener for a screw tool miniaturized or refined by precise processing for assembling various types of small-sized products; and a method and an apparatus for manufacturing the fastener. The fastener (10) such as a nut, an insert, etc. is to be fastened with a screw tool (30) such as a screw, a bolt, etc; and a concavity (18) is formed by press-forming from the outside in a part of the outer circumferential wall of the fastener to form a reduced-diameter deformation part (20) where the diameter of the crest or bottom of the female thread is partially reduced in the inner circumferential wall of the fastener.

### TECHNICAL FIELD

The present invention relates to a fastener such as an insert, spacer, or nut or the like used for effecting fastening with screw tool such as a screw or bolt, and more particularly to a fastener in which a screw tool screwed into and secured to the fastener can be easily and assuredly prevented from loosening or coming off, and further relates to a manufacturing method and manufacturing apparatus of such a fastener.

### BACKGROUND TECHNOLOGY

Conventionally, when a screw tool such as screws or bolts are combined with fasteners such as nuts or inserts used for screwing and securing them, the screw tool screwed and secured to the fastener develops loosening caused by vibration or the like, and sometimes even comes completely off. From this perspective, conventionally, in combinations of screw tool and fasteners, various loosening-prevention methods and means, respectively, have been proposed and implemented for a screw tool and a fastener.

In early proposals, for example, there have been many innovations proposed, in which concavities are provided for the inner circumferential walls of nuts or through holes are provided from the outer circumferential walls, or the like, into which concavities or through holes elastic members are inserted so that they will not fall out, and, by providing configurations in which the tip surfaces of the elastic members are attached tightly in the threads of the bolts, loosening of the screw tool can be prevented.

Innovations have also been proposed in which, in a combination of a screw tool and a fastener, a resin is applied to the surface of the threads of the screw tool or fastener, so that the screw tool can be prevented from loosening by such properties of the resin as elasticity, friction, viscosity, and adhesiveness.

However, in the various loosening preventive means previously proposed, it is necessary to add complex processes when manufacturing them, making it very difficult to reduce manufacturing costs by mass production. Furthermore, it is being increasingly demanded that the screw tool and fasteners used in the assembly of various products that today are being made smaller and smaller exhibit greater fineness and precision, making it very difficult structurally to adopt the various loosening preventive means conventionally proposed for these types of screw tools and fasteners, and, naturally, the implementation thereof during manufacture is also very difficult.

From such a perspective, self-tapping thermoplastic resin insert parts, and a manufacturing method therefor, have been proposed (cf. Patent Literature 1), in which, for example, a self-tapping thermoplastic resin insert part is mounted in a lower die, the upper die is closed, and a molded cavity is formed by the upper die and lower die, after which a thermosetting resin is injected into the above-described cavity, and the insert part and thermosetting resin are integrally molded to form the self-tapping thermoplastic resin insert part. In other words, for the self-tapping thermoplastic resin insert part described in Patent Literature 1, it is disclosed that, by integrally molding the thermosetting resin, a benefit is realized in that it is possible to sharply improve repeated tightening, pull-out force, pull-out torque, and tightening force for internal threads.

Furthermore, a return preventing method for a internal thread body has been proposed (cf. Patent Literature 2) that uses an enveloped internal thread body in which a tubular outer covering member (thin material made of synthetic resin exhibiting a shrinking property) is mounted on the outer periphery of the internal thread body or on a holding body protrudingly provided at an outer face part of the internal thread body. The outer covering member contracts to adhere closely to the outer periphery of the internal thread body or the holding body of the internal thread body, and one side part in the outer covering member is contracted so as to have a smaller diameter than a root diameter in the internal thread on the internal thread body bearing surface side or on the other side, thus forming a locking part that protrudes in a specified length and engages the male thread of an external thread body. By screwing the internal thread body to the external thread body, after firmly fastening an article, or before screwing, a covering layer (setting resin or resinous coating or the like) is formed on the inner circumference or outer circumference of the locking part in the outer covering member, so that the internal thread member is prevented from returning.

More specifically, in the enveloped internal thread body and an internal thread body return prevention method described in Patent Literature 2, various benefits are disclosed, including that, when fastening an article, the locking part formed by the outer application of the outer covering member to the internal thread body engages the external threads of the external thread body, so that the external thread body and the internal thread body are made integral, so that a large return preventive effect can be manifested; and further, by providing a covering layer in the locking part, the opening of this locking part when screwing in the external threads is suppressed, and deterioration due to exterior factors can be prevented, and, furthermore, the internal thread body return preventing action can be continued as much as possible.

Furthermore, in a structure in which a piece being attached that has a fastening hole provided with countersinking at the top thereof is fastened and secured to a piece being attached to, a metal collar and a fastening structure using this metal collar have been proposed (cf. Patent Literature 3) in which this metal collar is a metal collar that is mounted inside the fastening hole of the above-described piece being attached, and the configuration is such that the total length of the metal collar is formed so as to be longer than the length of the fastening hole, and such that one portion corresponding to the countersinking is elastically deformed inside the countersinking by pressure applied from the long direction.

In other words, with respect to the metal collar and the fastening structure using this metal collar described in this Patent Literature 3, what is disclosed is that the metal collar is compression-deformed inside the countersinking provided in the fastening hole in the piece being attached, so that imparting a reaction force to the above-described fastening means, that is, that an energizing force is applied to the fastening member(s) by the elastic return force (spring-back force) at the insertion end of the metal collar that is buckle deformed, and as a result, the benefit of being able to stop the loosening of the fastening member(s) is realized. Furthermore, a loosening preventive internal thread structure and manufacturing method therefor have been proposed (cf. Patent Literature 4) in which, of the inlet end and outlet end where internal threads are screwed to a external thread member, the outlet end is given a reduced diameter, making a tapered shape, about the entire circumference, so that the inner diameter of the internal threads becomes smaller than the intermediate part, to form internal threads of reduced diameter having a conical cross-section, and, for irregularities for repeatedly continuing the thread crests of these reduced-diameter internal threads in the circumferential direction, they are formed so that the convex parts thereof protrude on the center side of the reduced-diameter internal threads, and so that the concave parts thereof retract from the center side of the reduced-diameter internal threads, so that, when the external thread member is screwed to these internal threads, the plurality of convex parts of the irregularities in the thread crests of the reduced-diameter internal threads presses against the roots and thread flank surfaces of the external thread member, so that when elastically compressed by the reaction thereof, the external thread member is tightened from the outer circumference.

More specifically, in the loosening preventive internal thread structure and manufacturing method therefor described in this Patent Literature 4, the reduced-diameter internal threads having a conical cross-section are formed by way of reducing the diameter in a tapered shape about the entire circumference, so that the inner diameter of the internal threads of the outlet end is smaller than the intermediate part. Accordingly, it is difficult for variation in internal thread deformation to appear, as in a case that a pressing force is applied to a part of the entire circumference to cause deformation; and further, irregularities are formed which repeatedly continue in the circumference direction of the thread crests of the internal threads of reduced diameter, and the convex parts of these irregularities make contact uniformly, about the entire circumference, with the threads of the external thread member. As a result, friction can be reduced, when viewed locally, compared to a conventional case in which pressure is applied to the entire circumference of thread crests, and burning does not readily occur; and further, because the tightening force acts uniformly over substantially the entire circumference due to the convex parts of the irregularities that continuously repeat, the loosening preventive effect is great.

Furthermore, a loosening preventive nut and manufacturing method therefor have been proposed (cf. Patent Literature 5) in which the loosening preventive nut is one that is screwed to a external screw tool such as a bolt, for fastening a member to be secured, and this nut comprises: a main nut body, an extension that is extended coaxially with the main nut body, a main internal thread part formed on the inner circumferential wall of the main nut body, a ring-shaped channel formed either in the inner circumferential wall on the main nut body side of the extension or in the inner circumferential wall of the main nut body, with a diameter that is either the same as or larger than the root diameter of the main internal thread part, and an auxiliary internal thread part formed on the inner circumferential wall of the extension with the phase relative to the main internal thread part displaced 12 to 100° but preferably 24 to 90° and more preferably 24 to 72°.

In other words, in the loosening preventive nut and manufacturing method therefor described in this Patent Literature 5, the loosening preventive nut is of a simple structure that exhibits outstanding amenability to mass production, decreases in screw-fastening force, when an external force acts on a bolt or member to be fastened to or the like, can be prevented, a large fastening force can be maintained almost indefinitely, the safety of the fastening of the member to be fastened to can be sharply enhanced, the fastening operation is easy, and repeat usability is outstanding.

Patent Literature 1: Japanese Patent Application Laid-Open (Kokai) No. 3-244814

Patent Literature 2: Japanese Patent Application Laid-Open (Kokai) No. 10-184650

Patent Literature 3: Japanese Patent Application Laid-Open (Kokai) No. 11-101218

Patent Literature 4: Japanese Patent Application Laid-Open (Kokai) No. 11-37129

Patent Literature 5: Japanese Patent Application Laid-Open (Kokai) No. 2004-3587

### DISCLOSURE OF INVENTION

### Problems the Invention Resolves

There is a trend today in which various industrially produced products, such as electrical appliances, are becoming smaller and smaller in conjunction with the miniaturization of electronic components and other components. Accordingly, when it comes to a screw tool and a fastener and the like used in assembling these various industrially produced products, there is a demand that they be precision-machined, and that their dimensions be made smaller and finer.

From such a perspective, looking at the conventional loosening preventive means for a screw tool and a fastener and the like described in the foregoing, for those in which a concavity or through hole is provided and an elastic member is mounted, when precision machining is required, or they must be made very small or very fine, not only is the manufacturing thereof very difficult, but they are also extremely problematic structurally.

Furthermore, in a screw tool in which a resin or the like exhibiting the properties of elasticity, friction, viscosity, and adhesiveness and the like is applied to its thread surface, there are such difficulties that powder from the resin or the like developing due to friction during the use thereof moves or flies about, or that reuse is not possible due to deterioration of the resin or the like; and furthermore, it is also very difficult to manufacture such a screw tool when it is made very small or very fine, as noted earlier, by precision machining.

In the insert parts disclosed in the above-described Patent Literature 1, on the other hand, a self-tapping thermoplastic resin material is used, in which, in view of the properties of the base materials used, there are limitations on the objects to which they are applied, and, for a screw tool or a fastener made very small or very fine for use in the assembly of various miniaturized products as described above, there are structural difficulties in manufacturing these by precision machining.

Moreover, the jacketed internal threaded bodies disclosed in the above-described Patent Literature 2 are configured such that an outer covering member comprising a thin material made of a synthetic resin exhibiting a shrinking property is externally coated, and the outer covering member is shrunk by applying heat to a locking part engaged in the external threads, heightening the tight attachment to the surfaces of the external threads of the locking part. As a result, similarly as described above, for screw tools or fasteners that are made very small or very fine, there are structural difficulties with manufacturing them by precision machining, and there are also difficulties in that complexities arise in their manufacture and use.

In the metal collar and the fastening structure using this metal collar disclosed in the above-described Patent Literature 3, furthermore, for the object of bolt attachment, it is necessary to provide a fastening hole at the top where countersinking is provided, the configuration being made such that the total length of the metal collar is formed longer than the length of the fastening hole, and compression deformation is effected inside the countersinking. In this case as well, as described above, for a screw tool or a fastener made very small or very fine for use in the assembly of various miniaturized products as described above, there are structural difficulties in manufacturing these by precision machining, and there is a difficulty in that the method of use becomes particularly complex.

Furthermore, in the loosening preventive internal thread structure and manufacturing method therefor disclosed in the above-described Patent Literature 4, at the outlet end where the internal threads are screwed to the external thread member, the diameter is reduced in a tapered shape about the entire circumference so that the inner diameter of the internal threads becomes smaller than the intermediate part, to form reduced-diameter internal threads having a conical cross section, and irregularities are formed which repeatedly continue in the circumference direction relative to the thread crests of these reduced-diameter internal threads. In view of the fact that the shape and structure of the above-described continuing irregularities become extremely complex as described above, it is very difficult to manufacture screw tools or fasteners that are very small or very fine so as to be used in the assembly of various miniaturized products.

Moreover, in the loosening preventive nut and manufacturing method therefor disclosed in the above-described Patent Literature 5, a ring-shaped channel, having a diameter that is either the same as or larger than the root diameter of the main internal thread part, is formed either in the inner circumferential wall of the main nut body or in the inner circumferential wall on the main nut body side of the extension provided coaxially with the main nut body, and an auxiliary internal thread part formed in the inner circumferential wall of the extension is configured such that a prescribed phase displacement develops relative to the main internal thread part. Because the shape and structure of the ring-shaped channel become extremely complex, it is very difficult to manufacture, by precision machining, screw tools or fasteners that are very small or very fine so as to be used in the assembly of various miniaturized products.

In view of the above, the inventors of the present application succeeded in developing a fastener for preventing loosening of a screw tool, as well as a manufacturing method and manufacturing apparatus therefor, in which the screw tool or fastener is very small or very fine and precision-machined so as to be used particularly in the assembly of various miniaturized products, has a simple structure, is easy to manufacture, and makes the costs associated with mass production lower.

More specifically, the present invention relates to a fastener, such as an insert, spacer, or nut, that is fastened with a screw tool such as a screw or bolt; and in this fastener, a concavity is provided in a part of the outer circumferential wall by pressure-forming from the outside, and a reduced-diameter deformation part, in which the diameter of the crests or roots of the internal threads in the inner circumferential wall of the fastener is partially reduced, is provided. The fastener is simple in structure, manufacture thereof is easy, and it can be mass-produced to effect the cost reductions; and further it is a very small and very fine fastener made by precision machining so as to be used particularly in assembling various miniaturized products. It was confirmed that the fastener is able to accomplish prevention of loosening of a screw tool easily and definitely.

Accordingly, an object of the present invention is to provide a loosening preventive fastener for screw tool, as well as a manufacturing method and manufacturing apparatus therefor, in which the structure of the loosening preventive fastener for screw tool is comparatively simple, manufacture thereof is easy, and it is possible to effect the cost reductions associated with mass production, so that the fastener is for a screw tool that is made very small or very fine by precision machining and is used particularly in the assembly of various miniaturized products, and further the fastener is able to easily and definitely prevent loosening of a screw tool.

### Means for Resolving the Problems

In order to attain the object stated above, the loosening preventive fastener for screw tool of the present invention described in claim 1 is characterized in that it is configured so that it is a fastener such as an insert, spacer, or nut for making fastening with a screw tool such as a screw or bolt, and characterized in that a concavity pressure-formed from the outside is provided in a part of the outer circumferential wall of the fastener, and a reduced-diameter deformation part in which the diameter of the crests or roots of the internal threads in the inner circumferential wall of the fastener is partially reduced is provided.

The loosening preventive fastener for screw tool of the present invention described in claim 2 is characterized in that the fastener is configured such that a thinly formed portion of a prescribed width and made thinner entirely or partially in the circumferential direction thereof is provided in a part of the outer circumferential wall of the fastener, and a concavity pressure-formed from the outside is provided at least in a part of this thinly formed portion, and the reduced-diameter deformation part in which the diameter of the crests or roots of the internal threads in the inner circumferential wall of the fastener is partially reduced is provided.

The loosening preventive fastener for screw tool of the present invention described in claim 3 is characterized in that it is formed with a plurality of concavities pressure-formed in the outer circumferential wall of the fastener so as to be displaced in the axial direction of the fastener, and thus a plurality of reduced-diameter deformation parts are provided in the inner circumferential wall of the fastener.

The method for manufacturing a loosening preventive fastener for screw tool of the present invention described in claim 4 is characterized in that it forms, in a part of the outer circumferential wall of a fastener such as an insert, spacer, or nut that fastens with a screw tool such as a screw or bolt, a concavity that is pressure-formed at a part of the outer circumferential wall from outside of the fastener, so that the diameter of the internal thread crests or roots in the inner circumferential wall of the fastener is partially deformed to be reduced.

The method for manufacturing a loosening preventive fastener for screw tool of present invention described in claim 5 is characterized in that when pressure-forming the concavity in a part of the outer circumferential wall from outside the fastener, pressure forming is effected by rolling dies that are provided with a convexity for forming the concavity.

The method for manufacturing a loosening preventive fastener for screw tool of the present invention described in claim 6 is characterized in that when providing the thinly formed portion in a part of the outer circumferential wall of the fastener, pressure forming is effected by rolling dies that are provided with a protruding ledge for forming the thinly formed portion and a convexity for forming the concavity.

The method for manufacturing a loosening preventive fastener for screw tool of the present invention described in claim 7 is characterized in that when forming the thinly formed portion in a part of the outer circumferential wall of the fastener, the thinly formed portion is formed by cutting machining, and the concavity is pressure-formed in at least a part of this thinly formed portion by a pressing means such as a punch from the outside.

The apparatus for manufacturing a loosening preventive fastener for screw tool of the present invention described in claim 8 is characterized in that it comprises a fastener manufacturing apparatus and a concavity forming means, wherein the fastener manufacturing apparatus continuously manufactures fasteners such as inserts, spacers, and nuts that fastens with a screw tool such as screws or bolts, and the concavity forming means comprises rolling dies for pressure-forming, from the outside of the fastener, a concavity in a part of the outer circumferential wall of the fastener, thus pressure-forming a reduced-diameter deformation part in which a diameter of the crests or roots of the internal threads in the inner circumferential wall of said fastener is partially reduced.

The method for utilizing a loosening preventive fastener for screw tool described in claim 9 is characterized in that a screw tool, which is for preventing loosening and dropping away formed by applying a resin or the like partially or entirely to its external thread portion, and the loosening preventive fastener for screw tool, which is described in any one of claims 1 to 3 described above, are combined.

### BENEFITS OF INVENTION

According to the loosening preventive fastener for screw tool described in claims 1 to 3 for the present invention, it is a screw tool fastener made very small and very fine by precision machining, particularly used in the assembly of various miniaturized products, and it has a comparatively simple structure, is easy to manufacture, and realizes the lower costs associated with mass production; and preventing of a screw tool from loosening can be easily and definitely accomplished.

Furthermore, for the loosening preventive fastener for screw tool of the present invention, an ordinary screw tool can be used; and upon mating of the fastener with the screw tool, neither parts are damaged, and as a result, it is possible to reuse both the screw tool and the fastener repeatedly.

In particular, in the loosening preventive fastener for screw tools of the present invention, the diameter of the crests of the internal threads (the same being true of the roots thereof) in the inner circumferential wall of the fastener is set so that the radius r′ of the reduced-diameter deformation part 20 relative to the prescribed radius r is made smaller (r>r′); accordingly, when the fastener is screwed together with a screw tool, the external threads of the screw tool will be pressure-tightened, with prescribed tightening force, in the reduced-diameter deformation part; as a result, loosening or falling away of the screw tool with respect to the fastener caused by vibration or other fluctuations can be assuredly prevented.

Furthermore, when the loosening preventive fastener for screw tool of the present invention is used in conventional screw tightening operations, tightening with a comparatively large torque when subjecting the screw tool to final tightening will not be required. In other words, in screw tightening operations, when the external threads of the screw tool reach the reduced-diameter deformation part of the fastener, pressure tightening will be done with the prescribed tightening force, and effectiveness at this time in preventing loosening or falling away of the screw tool with respect to the fastener will be exhibited. As a consequence, with use of the loosening preventive fastener for screw tool of the present invention, when the fastener is attached to plastic boards or the like of low strength, final tightening of the screw tool with excessive tightening torque can be avoided, and damage to the boards and associated ill effects on the periphery thereof can be assuredly prevented.

Furthermore, the greatest merits of the loosening preventive fastener for screw tool of the present invention are that it is possible to repeatedly use the fastener together with a screw tool used therewith; and in this case, moreover, the tightening force and pressure tightening effects distinctive to the present invention can be sustained without deterioration, and loosening and falling away of the screw tool with respect to the fastener can be assuredly prevented, making the invention advantageous both economically and in terms of workability.

According to the method and apparatus for manufacturing the loosening preventive fastener for screw tool of the present invention described in claims 4 to 8, the structure is simple, and as a result, many outstanding advantages are obtained including that it is possible to manufacture fasteners in a wide range of types, from things of large dimension down to those which are made very small or very fine and precision-machined, and that it is possible to realize low-cost manufacturing by mass production by, for example, using the rolling dies conventionally used in the manufacture of screws and the like.

According to the combination of the loosening preventive fastener for screw tool and a screw tool which is a utilization method of the present invention described in claim 9, the friction force and viscous force of the external thread portion of the screw tool are added to the tightening force and pressure tightening action resulting from the reduced-diameter deformation part of the fasteners, so that extremely good loosening preventive effectiveness can be exhibited.

### BEST MODES FOR CARRYING OUT THE INVENTION

Next, embodiments of the loosening preventive fastener for screw tool, manufacturing method, and manufacturing apparatus thereof of the present invention will be described in detail with reference to the accompanying drawings.

### Embodiment 1

### Configuration of Loosening Preventive Fastener for Screw Tool

FIGS. 1 to 3 show one embodiment of a loosening preventive fastener for screw tool according to the present invention. FIG. 1 is a vertical cross-sectional view of the main portion of the loosening preventive fastener of this embodiment which shows the state that a screw tool is fastened to the fastener. FIG. 2 is a perspective view of the fastener of this embodiment. FIG. 3 is a cross-sectional view of the main portion taken along the line A-A of the fastener shown in FIG. 1.

In FIG. 1, the reference symbol 10A designates the fastener according to this embodiment. The fastener 10A is one that is used as an insert when an attaching board 32 is secured, as a cover board, to an attachment object 30, which is an integrated circuit board, with a prescribed intervening space S in between, and the fastener 10A is to secure this space S. Accordingly, the fastener 10A configured and deployed in this manner comprises, as shown in FIG. 2, a flange 14, which is provided at one end of a cylindrical main body 12 for securing to the attachment object 30, and internal threads 16, which are for properly screwing together with the external threads 36 of a screw tool 34 (see FIG. 1) and cut into the inner circumferential surface of the cylindrical main body 12.

The fastener 10A according to this embodiment, configured in this manner, is formed with a concavity 18 that is pressure-formed, from the outside, and provided in a part of the outer circumferential wall, at a substantially intermediate place, of the cylindrical main body 12 of the fastener 10A, and a reduced-diameter deformation part 20 in which the diameter of the crests or roots of the internal threads 16 in that part 20 in the inner circumferential wall of the fastener 10A is partially reduced is provided. More specifically, as shown in FIG. 3, the diameter of the crests of the internal threads 16 (the same being true of the roots thereof) in the inner circumferential wall in the reduced-diameter deformation part 20 of the fastener 10A is set so that the radius r′ of the reduced-diameter deformation part 20 relative to the prescribed radius r is made smaller (r>r′).

When a prescribed screw tool 34 is screwed together with the fastener 10A of this embodiment configured in this manner, the external threads of the screw tool 34 will be pressure-tightened with prescribed tightening force at the reduced-diameter deformation part 20 of the fastener 10A, so that loosening or falling away, of the screw tool 34 with respect to the fastener 10A, caused by vibration or other fluctuations, can be assuredly prevented. In this case, furthermore, in order to effectively manifest the effectiveness of stopping loosening of the screw tool 34 screwed to the fastener 10A, the position of the concavity 18 provided by being pressure-formed, from the outside, in the cylindrical main body 12 of the fastener 10A should preferably be set so that it is at an intermediate place of the screw tool 34 that is screwed together with the fastener 10A.

(Fastener Manufacturing Method)

FIG. 4 represents one embodiment of a manufacturing method for the fastener 10A according to this embodiment. More specifically, when manufacturing the fastener 10A of this embodiment comprising the above-described configuration, rolling dies 40 which are commonly used in the manufacture of screws and the like can be used as the pressing means for forming the concavity 18 in one part of the outer circumferential wall, at a substantially intermediate place, of the cylindrical main body 12 of the fastener 10A, from the outside thereof. In other words, as shown in FIG. 4, a convexity 44, for forming the concavity 18, is formed on one of the dies of the rolling dies 40 that include a stationary die 41 and a moving die 42, namely on the moving die 42; and with use of the rolling dies 40 having this convexity 44, the concavity 18 can be simply pressure-formed in a part of the outer circumferential wall of the fastener 10A in a similar way as when manufacturing a conventional screw or the like.

As an alternative proposal, furthermore, it is also possible to form, from the outside, the same concavity 18 as described above, in a part of the outer circumferential wall at a substantially intermediate place in the cylindrical main body 12 of the fastener 10A by using a pressing means such as an ordinary punch instead of the rolling dies 40.

FIGS. 5 and 6 represent a modification example of the fastener 10A and manufacturing method therefor described above. More specifically, in the fastener 10A′ of this embodiment, as shown in FIG. 5, a plurality of concavities 18 (at two locations in the example shown) is respectively provided in the outer circumferential wall of the cylindrical main body 12 with displacements being made both in the axial direction and in the circumferential direction of the fastener 10A′, so that a plurality of reduced-diameter deformation parts 20a and 20b are provided, respectively, in the inner circumferential wall in which the internal threads 16 are formed. Accordingly, when manufacturing the fastener 10A′ configured in this manner, convexities 44a and 44b are as shown in FIG. 6, formed in one of the dies in the rolling dies 40, namely in the moving die 42, for forming the plurality of concavities 18; and with use of the dies 40 having the convexities 44a and 44b, it is possible to simply pressure-form the plurality of concavities 18 in parts of the outer circumferential wall of the fastener 10A′, in a similar manner as described above. Thus, by increasing the established number of the concavities 18 to a plurality of numbers, that is, to two or greater, the functioning as a loosening preventive fastener for screw tool can be appropriately enhanced.

According to the fasteners 10A and 10A′ of this embodiment, as described above, not only can ordinary screw tool be used for the screw tool 34; however, when mating the screw tool and the fastener, neither is damaged, and as a result, both the screw tool and the fastener can be reused. In addition, because the structure is simple, many outstanding advantages are obtained, including that it is possible to manufacture fasteners in a wide range of types, from things of large dimension down to those which are made very small or very fine and precision-machined, and that it is possible to realize low-cost manufacturing by mass production

### Embodiment 2

### Configuration of Loosening Preventive Fastener for Screw Tool

FIGS. 7 to 9 show another embodiment of a loosening preventive fastener for screw tool according to the present invention. FIG. 7 is a vertical cross-sectional view of the main portion of the loosening preventive fastener of this embodiment. FIG. 8 is a perspective view of the fastener of this embodiment. FIG. 9 is a cross-sectional view of the main portion taken along the line B-B of the fastener shown in FIG. 7. To facilitate the description, furthermore, the same reference symbols are applied to component parts that are the same as those in the fastener of embodiment 1 described above.

In FIG. 7, the reference symbol 10B designates a fastener according to this embodiment. This fastener 10B is a fastener that functions as an insert, similar to the above-described embodiment 1; however, the cylindrical main body 12 of the fastener is configured so as to be materially thick. Accordingly, the fastener 10B in this manner has, as shown in FIG. 8, a flange 14 provided at one end of the cylindrical main body 12 for securing to the attachment object 30, and internal threads 16 for properly screwing together with the external threads 36 of the screw tool 34 (see FIG. 1) are cut into the inner circumferential surface of the cylindrical main body 12.

The fastener 10B according to this embodiment is configured such that a thinly formed portion 19, made thinner for a constant width in the circumferential direction, is provided in one part of the outer circumferential wall, at a substantially intermediate place, on the cylindrical main body 12 of the fastener 10B, and a concavity 19a is provided by being pressure-formed, from the outside, in at least a part of the thinly formed portion 19. As a result, a reduced-diameter deformation part 20 in which the diameter of the crests or roots of the internal threads 16 in the inner circumferential wall of the fastener 10B is partially reduced is provided. More specifically, as shown in FIG. 9, the diameter of the crests of the internal threads 16 (the same being true of the roots thereof) in the inner circumferential wall of the fastener 10B is set so that the radius r′ of the reduced-diameter deformation part 20 relative to the prescribed radius r is made smaller (r>r′). When prescribed screw tool 34 is screwed together with the fastener 10B configured in this manner, the external threads of the screw tool 34 will be pressure-tightened with prescribed tightening force at the reduced-diameter deformation part 20 of the fastener 10B, so that loosening or falling away of the screw tool 34 with respect to the fastener 10B, caused by vibration or other fluctuations, can be assuredly prevented.

(Fastener Manufacturing Method)

FIG. 10 represents one embodiment of a manufacturing method for the fastener 10B according to this embodiment. More specifically, when manufacturing the fastener 10B of this embodiment that comprises the above-described configuration, rolling dies 40 which are commonly used in the manufacture of screws and the like can be used as a pressing means for forming, from the outside, the thinly formed portion 19, which is thinner than other parts for a constant width in the circumferential direction, and the concavity 19a in one part of the outer circumferential wall, at a substantially intermediate place, on the cylindrical main body 12 of the fastener 10B. In other words, as shown in FIG. 10, a protruding ledge 46 for forming the thinly formed portion 19 and a convexity 46a for forming the concavity 19a are formed on one of the dies of the rolling dies 40 that include a stationary die 41 and a moving die 42, namely on the moving die 42; and with use of the rolling dies 40 having the protruding ledge 46 and convexity 46a, the thinly formed portion 19 and the concavity 19a can be simply pressure-formed in a part of the outer circumferential wall of the fastener 10B in a similar way as when manufacturing a conventional screw or the like.

With the fastener 10B of this embodiment as well, as described above, not only can ordinary screw tool be used for the screw tool 34; however, when mating the screw tool and the fastener, neither is damaged, and as a result, both the screw tool and the fastener can be reused. In addition, because the structure is simple, many outstanding advantages are obtained including that it is possible to manufacture fasteners in a wide range of types, from things of large dimension down to those which are made very small or very fine and precision-machined, and that it is possible to realize low-cost manufacturing by mass production.

### Embodiment 3

### Configuration of Loosening Preventive Fastener for Screw Tool

FIGS. 11 to 13 show yet another embodiment of a loosening preventive fastener for screw tool according to the present invention. FIG. 11 is a vertical cross-sectional view of the main portion of the loosening preventive fastener of this embodiment. FIG. 12 is a perspective view of the fastener of this embodiment. FIG. 13 is a cross-sectional view of the main portion taken along the line C-C of the fastener shown in FIG. 11. To facilitate the description, furthermore, the same reference symbols are applied to constituting elements that are the same as those in the fastener of embodiment 1 described above.

In FIGS. 11 and 12, the reference symbol 10C designates a fastener according to this embodiment. This fastener 10C is a fastener configured as a hexagonal nut. In the inner circumferential surface of this hexagonal nut main body 13 of the fastener 10C, internal threads 16 are cut for properly screwing together with the external threads of the screw tool shown in FIG. 1, for example.

The fastener 10C according to this embodiment is configured such that a thinly formed portion 22 is provided in one part of the outer circumferential wall, at a substantially intermediate place, on the hexagonal nut main body 13, by cutting machining or the like, from the outside, so that a concavity 22a is formed, in at least one part of this thinly formed portion 22, by being pressure-formed, from the outside, with a punch or the like 40. As a result, a reduced-diameter deformation part 20 in which the diameter of the crests or roots of the internal threads 16 in the inner circumferential wall of the fastener 10C is partially reduced is provided.

(Fastener Manufacturing Method)

Accordingly, in the fastener 10C according to this embodiment configured in this manner, as shown in FIG. 12(a), the thinly formed portion 22 is formed on one side of the outer circumferential wall, at a substantially intermediate place, on the hexagonal nut main body 13, by performing cutting machining in the shape of a linear channel having a prescribed width, and then by pressing, from the outside, with a punch or the like 40 at least one place in the thinly formed portion 22 formed in this manner, the above-described concavity 22a is formed.

As an alternative proposal, as shown in FIG. 12(b), it is also possible to form the thinly formed portion 22 by performing machining to cut a circular hole having a prescribed diameter in the center part on one side of the outer circumferential wall, at a substantially intermediate place on the hexagonal nut main body 13, and then by pressure-forming, with a punch or the like 40, from the outside, at least one part of the thinly formed portion 22 formed in this manner, the above-described concavity 22a is formed.

Accordingly, in the fastener 10C of this embodiment manufactured in this manner, as shown in FIG. 13, the diameter of the crests of the internal threads 16 (the same being true of the roots thereof) in the inner circumferential wall of the fastener 10C is set so that the radius r′ of the reduced-diameter deformation part 20 relative to the prescribed radius r is made smaller (r>r′). When prescribed screw tool is screwed together with the fastener 10C, configured in this manner, the external threads of the screw tool will be pressure-tightened with prescribed tightening force at the reduced-diameter deformation part 20 of the fastener 10C, so that loosening or falling away of the screw tool with respect to the fastener 10C, caused by vibration or other fluctuations, can be assuredly prevented.

With the fastener 10C of this embodiment as well, as described above, ordinary screw tool can be used for the screw tool 34; and, when mating the fastener and the screw tool together, neither is damaged, and as a result, it is possible to reuse both the screw tool and the fastener. In addition, because the structure is simple, many outstanding advantages are obtained including that it is possible to manufacture fasteners in a wide range of types, from things of large dimension down to those which are made very small or very fine and precision-machined, and that it is possible to realize low-cost manufacturing by mass production.

### Embodiment 4

### Apparatus for Manufacturing a Loosening Preventive Fastener for Screw Tool

FIG. 14 is a simplified illustration of the structure of a manufacturing apparatus for continuously manufacturing the loosening preventive fastener for screw tool 10A, 10A′, and 10B according to the present invention described above. More specifically, when manufacturing the fasteners of the present invention, a product 53 can be finished as a loosening preventive fastener for screw tool of the present invention by: a fastener material supply means 50; a fastener manufacturing apparatus 51 for continuously manufacturing fasteners such as nuts or inserts; and a concavity forming means 52 including rolling dies for forming a concavity by pressure forming, from the outside, at a part of the outer circumferential wall of the fastener and forming a reduced-diameter deformation part in which the diameter of the crests or roots of the internal threads in the inner circumference wall of the fastener is partially deformed to be reduced.

### Embodiment 5

### Examples of Use of Loosening Preventive Fastener for Screw Tool

The loosening preventive fastener for screw tools according to the embodiments described above of the present invention can be used in combinations with ordinary screw tool that is generally commercially marketed; and in such a use, the screw tool loosening preventive effects distinctive to the present invention, as described above, can be effectively and definitely manifested.

In particular, it is possible to use the fastener of the invention in combinations with generally commercially marketed screw tool in which the external thread portion is coated with a resin or the like to prevent loosening and falling away. In such cases, the friction force and viscous force and the like of the external thread portion are added to the tightening force and tightening action effected by the reduced-diameter deformation part of the fasteners, so that extremely good loosening preventive effects can be manifested.

In the foregoing, suitable embodiments of the present invention are respectively described. However, the present invention is not limited to or by the above-described embodiments, and the invention can be applied to a broad range of fasteners, including not only inserts, spacers, and nuts used conventionally as fasteners, but also to those having various shapes, configurations, and applications used as various screw tool fastening means; and, in addition, many design modifications can be effected within such the scope that the essence of the present invention is not departed from.

### BRIEF DESCRIPTION OF THE DRAWINGS

FIG. 1 is a vertical cross-sectional view of the main portion of a loosening preventive fastener for screw tool according to one embodiment of the present invention, showing the state that a screw tool is fastened to the fastener.

FIG. 2 is a perspective view of the fastener according to the present invention shown in FIG. 1.

FIG. 3 is a cross-sectional view of the main portion taken along the line A-A of the fastener according to the present invention shown in FIG. 1.

FIG. 4 is a simplified explanatory illustration representing an embodiment of rolling dies for manufacturing the loosening preventive fastener for screw tool according to the present invention shown in FIG. 1.

FIG. 5 is a cross-sectional view of the main portion, similar to FIG. 3, representing a modification example of a loosening preventive fastener for screw tool according to the present invention.

FIG. 6 is a simplified explanatory illustration representing another embodiment of rolling dies for manufacturing the loosening preventive fastener for screw tool according to the present invention shown in FIG. 5.

FIG. 7 is a vertical cross-sectional view of the main portion of another embodiment of a loosening preventive fastener according to the present invention.

FIG. 8 is a perspective view of the loosening preventive fastener for screw tool according to the present invention shown in FIG. 7.

FIG. 9 is a cross-sectional view of the main portion taken along the line B-B of the loosening preventive fastener for screw tool according to the present invention shown in FIG. 7.

FIG. 10 is a simplified explanatory illustration representing an embodiment of rolling dies for manufacturing the loosening preventive fastener for screw tool according to the present invention shown in FIG. 7.

FIG. 11 is a vertical cross-sectional view of the main portion representing yet another embodiment of a loosening preventive fastener according to the present invention.

FIG. 12(a) is a perspective view of an example structure of the loosening preventive fastener for screw tool according to the present invention, and 12(b) is a perspective view of another example structure of the loosening preventive fastener for screw tool according to the present invention.

FIG. 13 is a cross-sectional view of the main portion taken along the line C-C of the loosening preventive fastener for screw tool according to the present invention shown in FIG. 11.

FIG. 14 is a block diagram showing a manufacturing apparatus for continuously manufacturing loosening preventive fastener for screw tools according to the present invention.

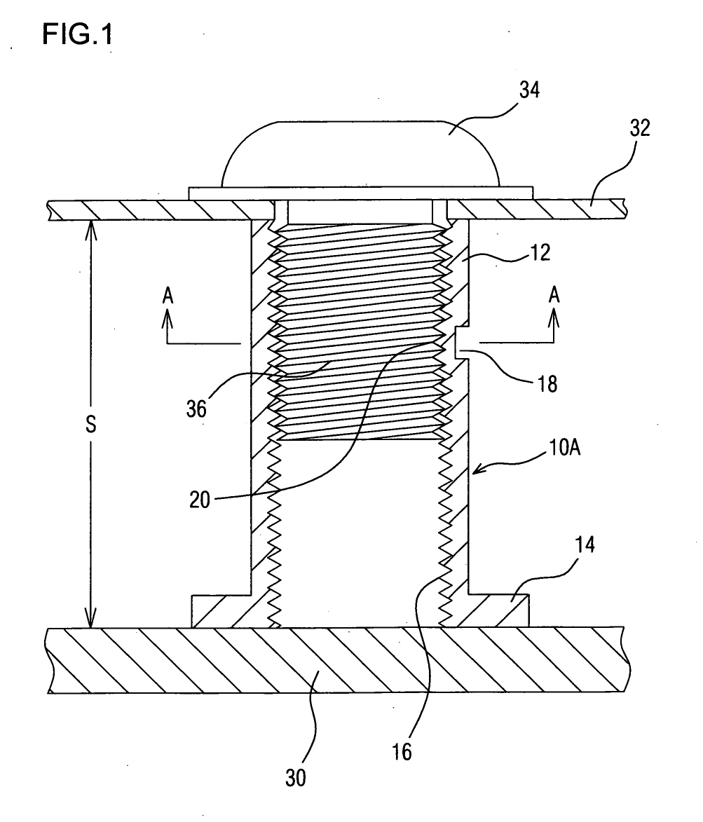

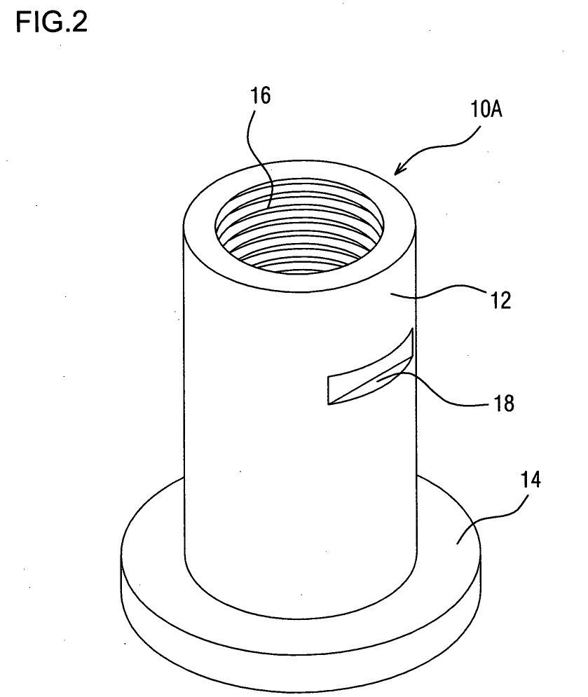

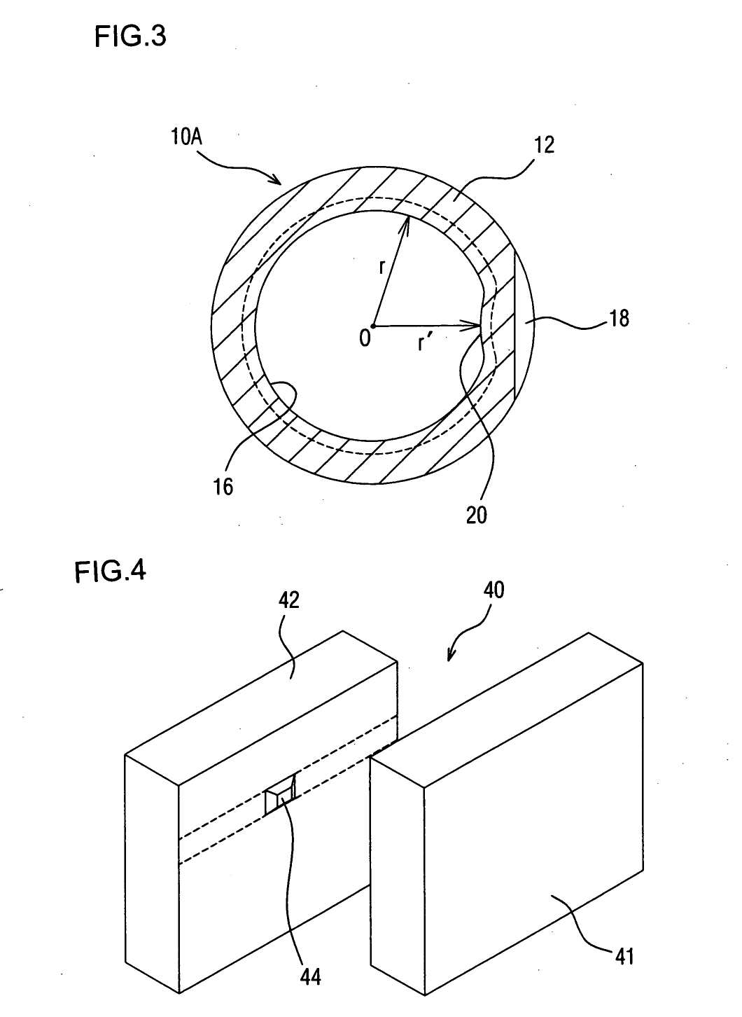

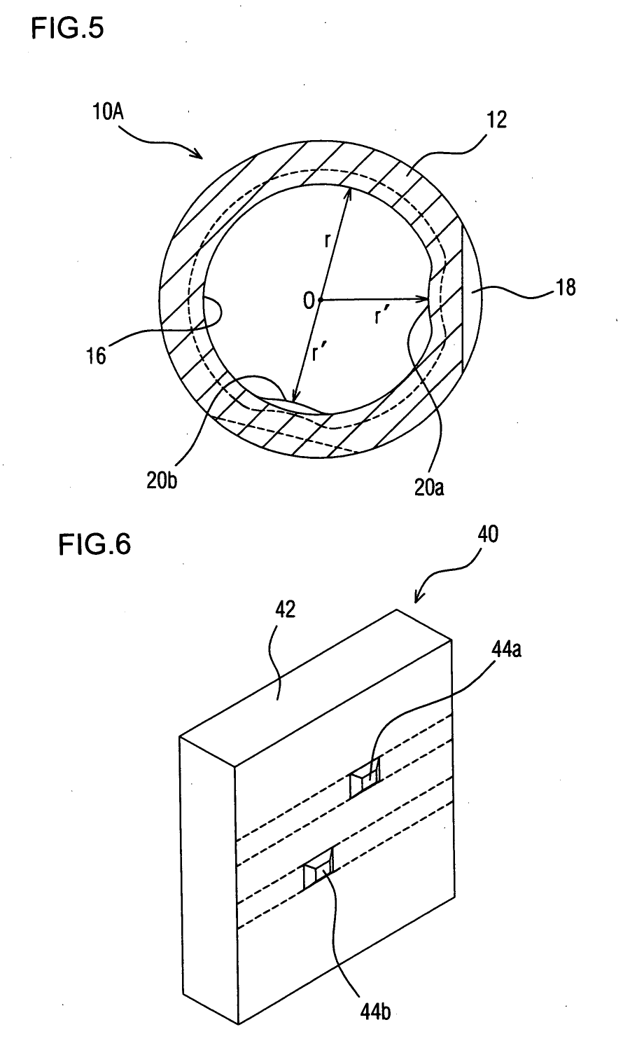

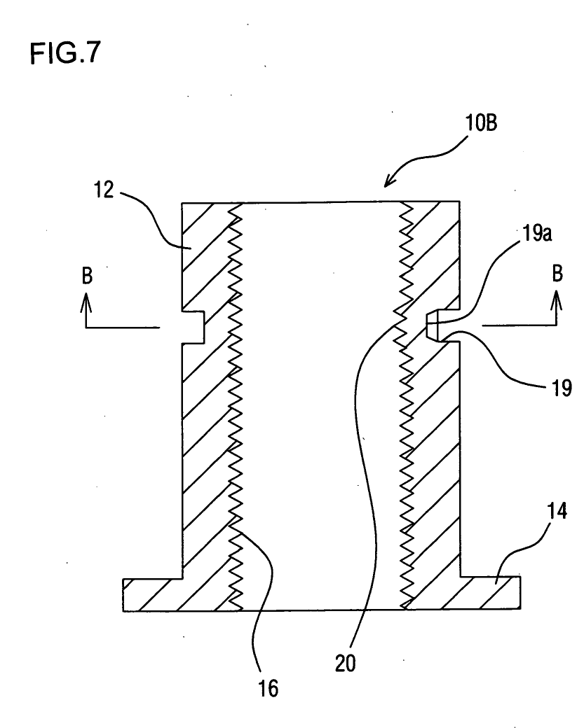

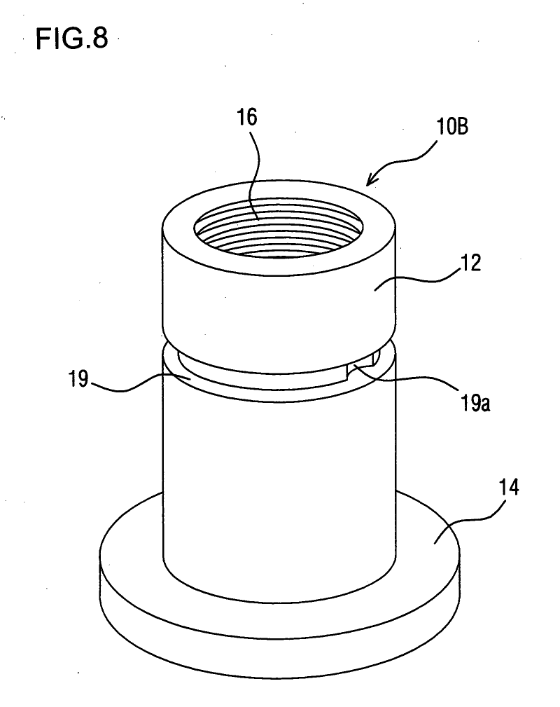

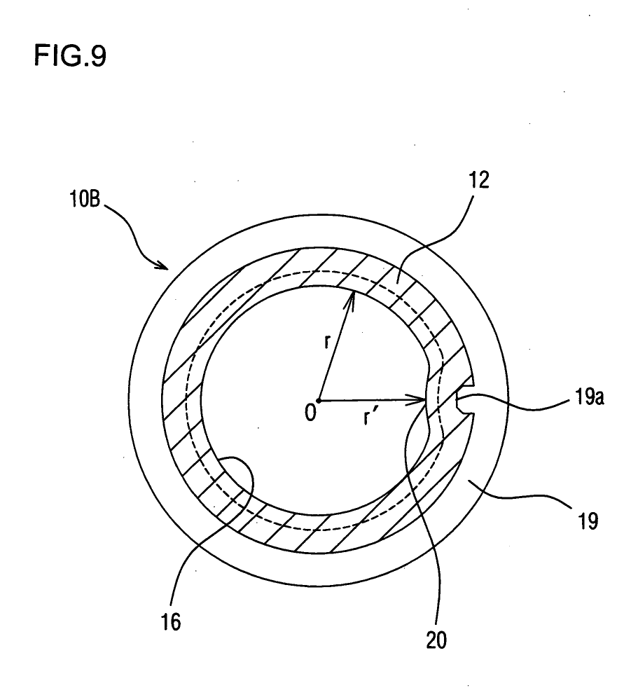

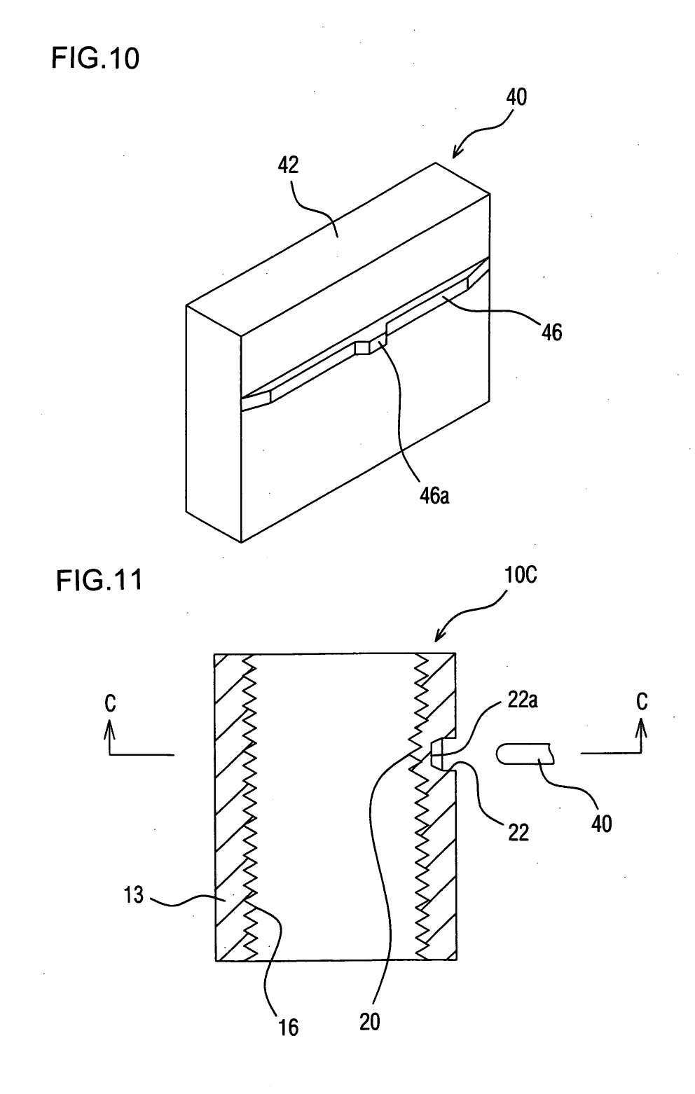

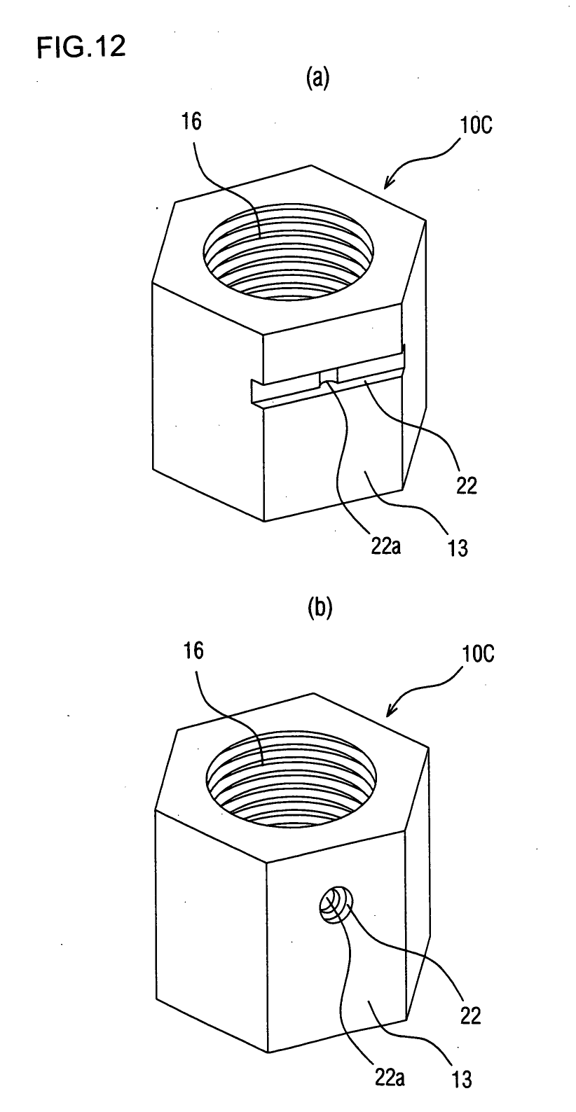

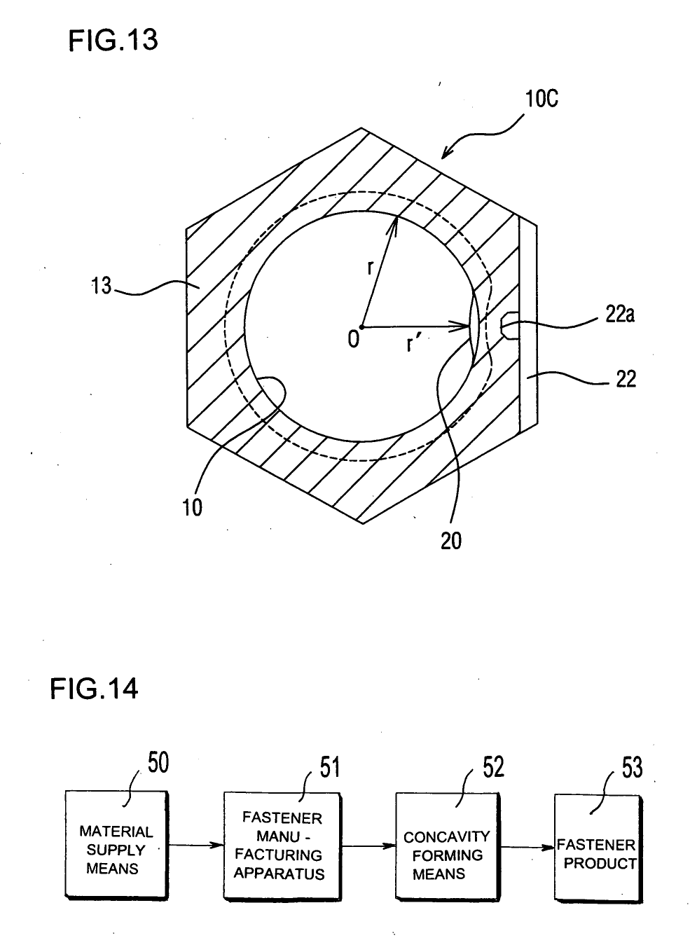

### EXPLANATION OF SYMBOLS

10A, 10A′ fasteners (inserts)
10B fastener (thin insert)
10C fastener (hexagonal nut)
12 cylindrical main body
13 hexagonal nut main body
14 flange
16 internal threads
18 concavity (formed by pressure forming)
19 thinly formed portion (formed by pressure forming)
19a portion pressure-formed
20 reduced-diameter deformation part
20a, 20b reduced-diameter deformation parts
22 thinly formed portion ([made] by cutting machining)
22a portion pressure-formed
30 attachment object
32 attaching board
34 screw tool
36 external threads
40 rolling dies
41 stationary die
42 moving die
44 convexity
44a, 44b convexities
46 protruding ledge
46a convexity
50 material supply means
51 fastener manufacturing apparatus
52 concavity forming means (for forming reduced-diameter deformation part)
53 fastener product
S space

1. A loosening preventive fastener for screw tool, said fastener being an insert or spacer for making fastening with a screw tool, characterized in that said fastener comprises a configuration in which a thinly formed portion is provided in a part of an outer circumferential wall of said fastener with said thinly formed portion being of prescribed width and made thinner in a circumferential direction thereof entirely or partially; a concavity is provided in at least a part of said thinly formed portion by being pressure-formed from an outside; and a reduced-diameter deformation part in which a diameter of crests or roots of internal threads in an inner circumferential wall of said fastener is partially reduced is provided.

2. (canceled)

3. The loosening preventive fastener for screw tool according to claim 1, wherein a plurality of thinly formed portions are provided in an outer circumferential wall so that said plurality of thinly formed portions are displaced in an axial direction of said fastener, have prescribed width, and are thinner in a circumferential direction, either entirely or partially; a plurality of concavities, respectively pressure-formed, is provided in at least a part of said thinly formed portions; and a plurality of reduced-diameter deformation parts are respectively provided in the inner circumferential wall of said fastener.

4. A method for manufacturing a loosening preventive fastener for screw tool, characterized in that a thinly formed portion, which is provided in a part of an outer circumferential wall of a fastener which is an insert or spacer for making fastening with a screw tool, has a prescribed width, and is made thinner in a circumferential direction thereof, either entirely or partially, in a part of the outer circumferential wall, from outside of said fastener, and a concavity, which is provided in at least a part of said thinly formed portion such that a diameter of crests or roots of internal threads in an inner circumferential wall of said fastener is partially deformed to be reduced, are respectively pressure-formed by rolling dies continuously; and a reduced-diameter deformation part in which a diameter of crests or roots of internal threads in an inner circumferential wall of said fastener is partially reduced is thus formed.

5. (canceled)

6. (canceled)

7. A method for manufacturing loosening preventive fastener for screw tool, characterized in that a thinly formed portion is formed, by cutting machining, in a part of an outer circumferential wall of a fastener which is an insert or spacer for making fastening with a screw tool, so as to have a prescribed width and is thinner in a circumferential direction thereof, either entirely or partially, in a part of the outer circumferential wall, from outside of said fastener; a concavity is pressure-formed, from the outside by a pressing means including a punch, in at least a part of said thinly formed portion such that diameter of crests or roots of internal threads in an inner circumferential wall of said fastener is partially deformed to be reduced; and a reduced-diameter deformation part in which a diameter of the crests or roots of the internal threads in the inner circumferential wall of said fastener is partially reduced is thus formed.

8. An apparatus for manufacturing a loosening preventive fastener for screw tool, characterized in that said apparatus comprises a fastener manufacturing apparatus for continuously manufacturing fasteners including which are inserts or spacers for making fastening with a screw tool; and a concavity forming means provided with rolling dies for pressure-forming a reduced-diameter deformation part in a part of an outer circumferential wall, from an outside, of each of said fasteners, by forming a thinly formed portion which is of a prescribed width, made thinner in a circumferential direction thereof, either entirely or partially, and forming a concavity by pressure forming in at least a part of said thinly formed portion such that a diameter of crests or roots of internal threads in an inner circumferential wall of said fastener is partially deformed to be reduced.

9. (canceled)
